(19) United States
(12) Patent Application Publication
(10) Pub. No.: US 2008/0200041 A1
(43) Pub. Date: Aug. 21, 2008

(54) STORAGE DEVICE

(75) Inventors: Chih-Wei Lin, Taipei County (TW); Chien-Hua Wu, Miaoli County (TW); Chia-Lin Shih, Taipei City (TW); Chia-Ming Chen, Tainan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: RITEK CORPORATION, Hsinchu Industrial Park (TW)

(21) Appl. No.: 11/675,645

(22) Filed: Feb. 16, 2007

(51) Int. Cl. H01R 12/00

(52) U.S. Cl. 439/62

(57) ABSTRACT

The present disclosure relates to a storage device. The storage device comprises a frame having a hole and a printed circuit board embedded in the frame, wherein the printed circuit board has an extended part for forming a connector. The connector may pass through the hole and is exposed out the frame for interfacing the storage device with a host device. At least one memory device is mounted to the printed circuit board and electrically connected to the printed circuit board.

### FIELD OF THE INVENTION

The present invention relates to a storage device, and more particularly to a storage device with a SATA interface.

### BACKGROUND OF THE INVENTION

All computers regardless of size are comprised of the same basic subsystems, a central processing unit, a means for displaying information, a means for entering information, and a means for storing data. Several means for storing data currently exist including floppy disk drives and hard or fixed disk drives. Floppy disk drives have a limited storage capacity usually one megabyte or less. The device most commonly used for storage of large amounts of data is the hard drive. The total memory capacity of a hard drive can range from 5-1000 megabytes. Through use of these computer devices, people can carry such personal information with them.

Despite the existence of other more easily portable computing devices (e.g., PDA), these devices lack the storage capacity to hold relatively large amounts of data as that can be stored in a hard disk. A solution is to replace the hard disk with solid-state memory. However, the typical 1.8-inch hard drive with solid-state memory only provides an IDE interface. That is the 1.8-inch hard drive with solid-state memory can only communicate with those portable electronic devices with IDE interface, which limits the development of the solid-state memory.

From the foregoing, it can be appreciated that it would be desirable to have another interface specification for a hard drive with solid-state memory.

A SATA interface specification has benefits of providing faster speed for data transfer, using a narrower Serial ATA data cable with seven conductors only and offering the ability of hot plugging. The smallest form factor of SATA hard drive nowadays is 2.5 inches. However, it is difficult to produce a 1.8-inch hard drive with the current device structure of 2.5-inch SATA hard drive. FIG. 5 illustrates the current 2.5-inch SATA hard drive. The 2.5-inch SATA hard drive comprises at least three components including printed circuit board 500 with at least one memory device 501, a connector 502 mounted on the printed circuit board 500 and the frame (not shown in this figure). It is the size of the connector limited such 2.5-inch structure to be used for 1.8-inch SATA hard drive. Therefore, another solution will be needed for 1.8-inch SATA hard drive.

This invention provides a viable solution for 1.8-inch SATA hard drive to be realized. Moreover, this invention provides a viable solution with much simpler structure than the structure of current 2.5-inch SATA device.

### SUMMARY OF THE INVENTION

Therefore, it is the main object of the present invention to provide a 1.8-inch storage device with a SATA interface.

The storage device comprises a frame having a hole and a printed circuit board embedded in the frame, wherein the printed circuit board has an extended part for forming a connector. The connector may pass through the hole and is exposed out the frame for interfacing the storage device with a host device. At least one memory device is mounted to the printed circuit board and electrically connected to the printed circuit board.

Accordingly, the storage device is small in size yet has a large storage capacity such that a user can carry with him or her a large volume of personal information.

Another object of this invention is to provide a storage device structure for easier and more economical manufacturing by integrating the connector with the printed circuit board. For SATA hard drives and those applications having connection specification similar to SATA, with the design of this invention described in the first object, the connector is not needed if compared with the three-component device. This makes the cost of the device of this invention cheaper. Moreover, mounting a connector to printed circuit board is not needed for this invention. Such that the manufacturing of a device with the structure of this invention is more economical and easier than a storage device with three-component structure.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1 illustrates an appearance of 1.8-inch hard drive with solid-state memory device according to one preferred embodiment of the present invention;

FIG. 2 illustrates an exploded view of 1.8-inch hard drive with solid-state memory device according to one preferred embodiment of the present invention;

FIG. 3 is an enlarged diagram of the printed circuit board and the frame; and

FIG. 4 is a diagram of the printed circuit board embedded into the frame.

FIG. 5 illustrates a tupical 2.5-inch SATA hard drive.

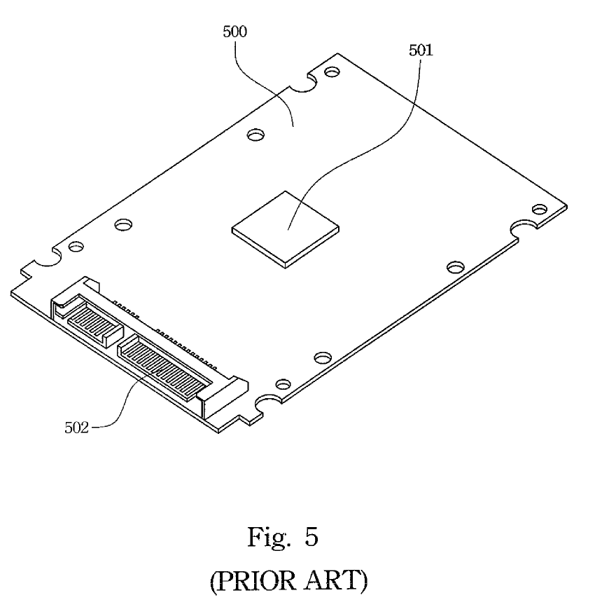

### DETAILED DESCRIPTION OF THE PREFERRED EMBODIMENT

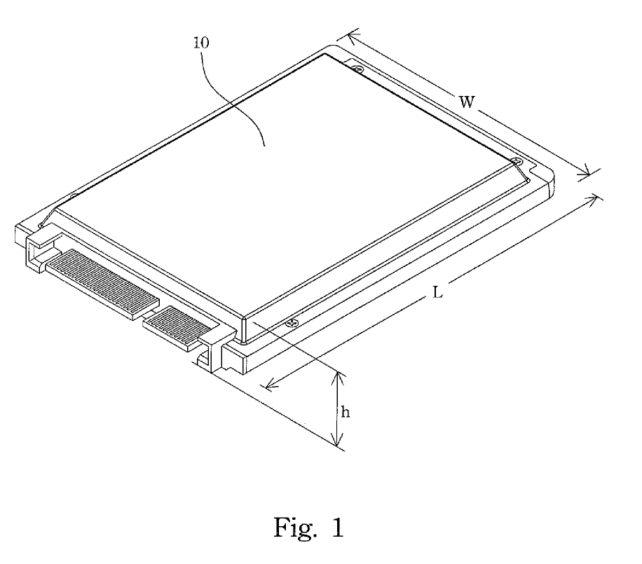

Referring now in more detail to the drawings, in which numerals indicate corresponding parts throughout the several views, FIG. 1 illustrates an appearance of 1.8-inch hard drive with solid-state memory device 10 according to one preferred embodiment of the present invention. Preferably, the 1.8-inch hard drive with solid-state memory device 10 is small in size so that the user can easily carry the device wherever he or she goes. According to one embodiment, the 1.8-inch hard drive with solid-state memory device 10 can have width (W), length (L), and thickness (H) dimensions of approximately 2.12 in, 3.04 in, and 0.31 in respectively.

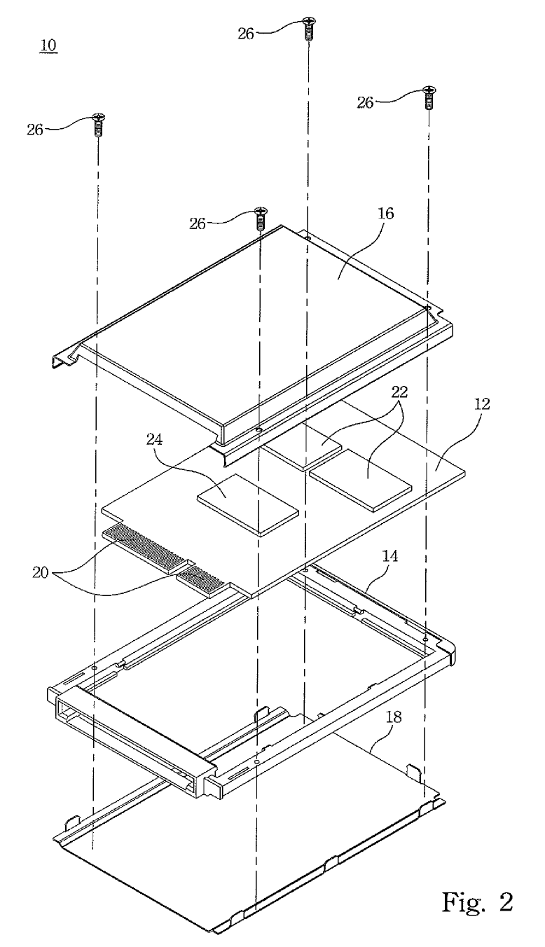

FIG. 2 illustrates an exploded view of 1.8-inch hard drive with solid-state memory device 10 according to one preferred embodiment of the present invention. The 1.8-inch hard drive with solid-state memory 10 typically comprises a printed circuit board (PCB) 12, a frame 14, and two opposed covers 16 and 18. In an embodiment, the printed circuit board 12, the frame 14 and two opposed covers 16 and 18 are fabricated together by screws 26.

The printed circuit board 12 has an extended part for forming a SATA connector 20. The SATA connector 20 includes many pins that are used to connect with a host. One or more memory devices 22 are electrically connected to the printed circuit board 12. The memory devices 22 are surface mounted to PCB 12 and electrically connected to the PCB 12 such that each memory device is in electrical communication with the other memory devices 22 to provide for storage redundancy. Each of the memory devices 22 typically is a non-volatile flash. In an embodiment, two memory devices are installed in the PCB 12. Each memory device 22 has a storage capacity of approximately 2 gigabytes (GB). Therefore, where two such memory devices are provided, a total storage capacity of approximately 4 GB can be achieved.

Moreover, the PCB 12 further includes at least one controller 24. This controller 24 typically comprises a semiconductor chip that is electrically connected to the memory devices 22 through the PCB 12. In an embodiment, the controller 24 can comprise an integrated circuit including control electronics and firmware. The controller 24 interfaces with the memory devices 22 and a host device (not shown), for instance a PDA.

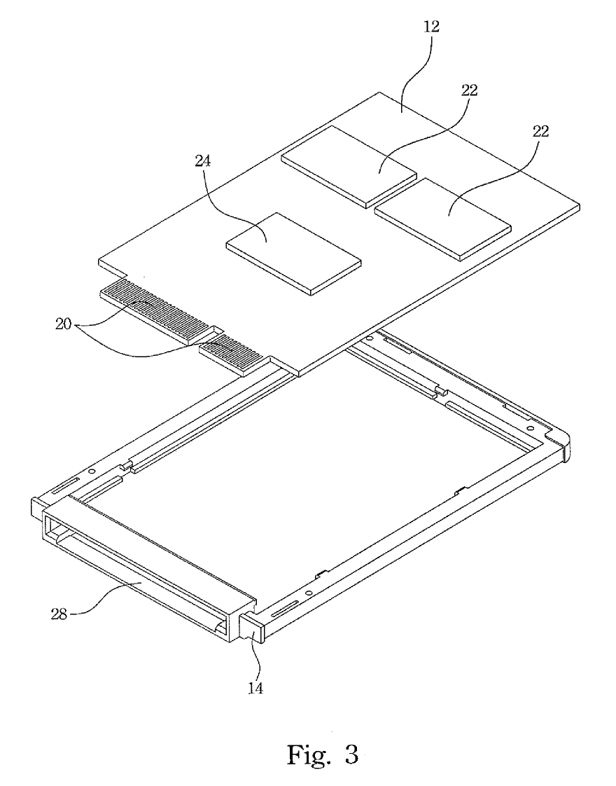

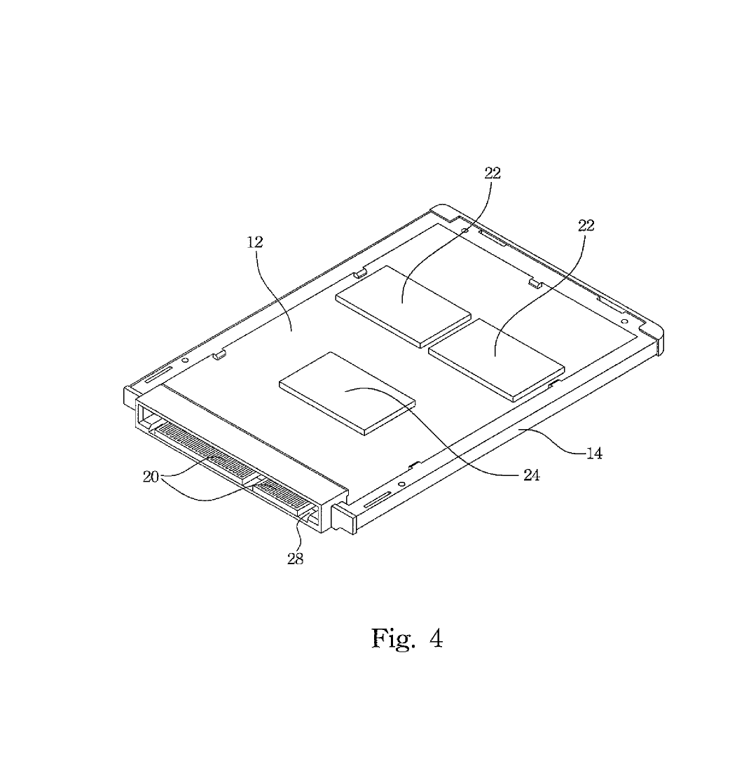

FIG. 3 is an enlarged diagram of the printed circuit board 12 and the frame 14. The material of the frame 14, for example, is plastic. The frame 14 may provide protection for the printed circuit board 12 when the printed circuit board 12 is embedded into the frame 14 as illustrated in the FIG. 4. In an embodiment, two trenches are formed in the inside of the frame 14. When the printed circuit board 12 is embedded into the frame 14, the edge of the printed circuit board 12 is fixed in the trenches. Moreover, the frame 14 has a hole 28. When the printed circuit board 12 and the frame 14 are fabricated together, the SATA connector 20 may pass through the hole 28 to expose out the frame 14.

As is understood by a person skilled in the art, the foregoing descriptions of the preferred embodiment of the present invention are an illustration of the present invention rather than a limitation thereof. Different applications, various modifications and similar arrangements are included within the spirit and scope of the appended claims. The scope of the claims should be accorded to the broadest interpretation so as to encompass all such modifications and similar structures. While a preferred embodiment of the invention has been illustrated and described, it will be appreciated that various changes can be made therein without departing from the spirit and scope of the invention.

What is claimed is:

1. A storage device, comprising:
a frame having a hole; and
a printed circuit board embedded in the frame, wherein the printed circuit board has an extended part, the extended part passes through the hole and is exposed out the frame for interfacing the storage device with a host device.

2. The storage device of claim 1, further comprising at least one memory device mounted to the printed circuit board and electrically connected to the printed circuit board.

3. The storage device of claim 2, further comprising a controller formed in the printed circuit board for interfacing the memory device and the host device.

4. The storage device of claim 2, wherein the memory device is a non-volatile flash.

5. The storage device of claim 1, further comprising two covers for housing the frame and the printed circuit board.

6. The storage device of claim 1, wherein the connector is a SATA connector.

7. The storage device of claim 1, wherein the storage device is no larger than approximately 2.12×3.04×0.31 inches in size.

8. The storage device of claim 1, wherein two trenches formed in the frame for fixing the printed circuit board when the printed circuit board embedded in the frame.

9. A storage device, comprising:
a frame having a hole; and
a printed circuit board embedded in the frame, wherein the printed circuit board has an extended part for forming a SATA connector, the connector passes through the hole and is exposed out the frame for interfacing the storage device with a host device, at least one memory device mounted to the printed circuit board and electrically connected to the printed circuit board, wherein the at least one memory device is a non-volatile flash.

10. The storage device of claim 9, further comprising a controller formed in the printed circuit board for interfacing the memory device and the host device.

11. The storage device of claim 9, further comprising two covers for housing the frame and the printed circuit board.
